(19) United States
(12) Patent Application Publication
(10) Pub. No.: US 2007/0235981 A1
(43) Pub. Date: Oct. 11, 2007

(54) Easy Lift

(76) Inventors: Ben L. Bohnett, Lapeer, MI (US); Pat M. Bohnett, Lapeer, MI (US)

Correspondence Address: ADVANTIA LAW GROUP, 9035 SOUTH 1300 EAST, SUITE 200, SANDY, UT, 84094, US

(21) Appl. No.: 11/278,857

(22) Filed: Apr. 6, 2006

(51) Int. Cl. B60D 1/66

(52) U.S. Cl. 280/475; 280/763.1

(57) ABSTRACT

A novel pair of manipulating rods adapted to manipulate the support legs of a fifth wheel travel trailer at least includes: a first rod adapted to disengage a support leg locking pin, the first rod having a pin engaging end and a handling end, the first rod being of sufficient length to allow a user to disengage the support leg locking pin without crouching under the fifth wheel travel trailer; and a second rod adapted to, while the support leg locking pin is disengaged, raise a support by engaging the second rod at a first end to the support leg near its free end, and a second end of the second rod adapted to being pulled by a user, the second rod also being of sufficient length to allow a user to raise the support leg without crouching under the fifth wheel travel trailer. The second rod at least includes: a main portion; a handle portion oriented at a non-right angle from the centerline of the main portion, and having at its end, a bent gripping portion; and a working portion oriented at a non-right angle from the centerline of the main portion, and having at its end, a hook portion adapted to grip a bolt member of the support leg.

### BACKGROUND OF THE INVENTION

1. Field of the Invention

The present invention generally relates to methods and apparatuses for adjusting the support legs of fifth wheel campers and the like.

2. Description of the Related Art

Fifth wheel campers and similar trailers typically have support legs which can be placed into a standing position for support of the trailer when the trailer is not connected to the primary vehicle. It is also common for the support legs to have adjustable heights. Many such trailers also allow the support legs to be retracted when a motorist desires to connect the trailer to a towing vehicle such as a Recreational Vehicle (RV).

Fifth wheel trailer support legs are awkward to reach, often requiring a motorist to uncomfortably crouch or kneel in order to manually carry out support leg engagement, disengagement and height adjustment activities. These activities can be especially uncomfortable and even painful for the elderly and those with handicaps.

What is therefore needed are apparatuses and methods for the convenient and practical engagement, disengagement and adjustment of fifth wheel trailer support legs without the need for kneeling, undue crouching or other body positioning and movement associated with skeletal-muscular strain.

### SUMMARY OF THE INVENTION

The present invention has been developed in response to the present state of the art, and in particular, in response to the problems and needs in the art that have not yet been fully solved. Accordingly, the present invention has been developed to provide a novel method for manipulating the support legs of a fifth wheel travel trailer, that at least includes: disengaging a support leg locking pin via a first rod having a pin engaging end and a handling end, the first rod being of sufficient length to allow a user to disengage the support leg locking pin without crouching under the fifth wheel travel trailer; and while the support leg locking pin is disengaged, raising a support leg via a second rod adapted to be engaged at a first end to the support leg near its free end, and a second end of the second rod adapted to being pulled by a user, the second rod also being of sufficient length to allow a user to raise the support leg without crouching under the fifth wheel travel trailer. The second rod at least includes: a main portion; a handle portion oriented at a non-right angle from the centerline of the main portion, and having at its end, a bent gripping portion; and a working portion oriented at a non-right angle from the centerline of the main portion, and having at its end, a hook portion adapted to grip a bolt member of the support leg.

The present invention has also been developed to provide a novel pair of manipulating rods adapted to manipulate the support legs of a fifth wheel travel trailer at least includes: a first rod adapted to disengage a support leg locking pin, the first rod having a pin engaging end and a handling end, the first rod being of sufficient length to allow a user to disengage the support leg locking pin without crouching under the fifth wheel travel trailer; and a second rod adapted to, while the support leg locking pin is disengaged, raise a support by engaging the second rod at a first end to the support leg near its free end, and a second end of the second rod adapted to being pulled by a user, the second rod also being of sufficient length to allow a user to raise the support leg without crouching under the fifth wheel travel trailer.

Reference throughout this specification to features, advantages, or similar language does not imply that all of the features and advantages that may be realized with the present invention should be or are in any single embodiment of the invention. Rather, language referring to the features and advantages is understood to mean that a specific feature advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 contains an oblique view of a prior art fifth wheel travel trailer with its support legs in full view; and

FIG. 2 contains a plan view of the present-inventive manipulating rods capable of lifting and manipulating the length of fifth wheel travel trailer support legs.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment.

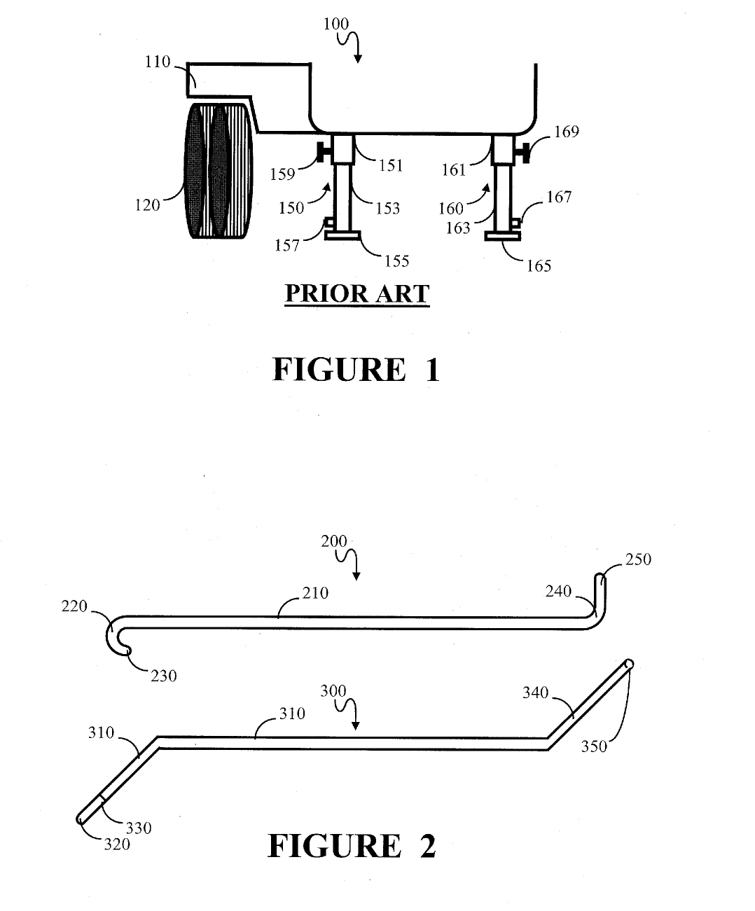

A general illustration of a fifth wheel travel trailer 100 is shown in FIG. 1. The trailer body 110 is supported by wheels 120 and support legs 150 and 160 when the trailer is disengaged from the towing vehicle. The support legs 150 and 160 have outer leg members 151 and 161, which have slidably fitted therein, inner leg members 153 and 163, respectively. The inner leg members have end plates 155 and 165 to help distribute the weight of the front end of the trailer over a wider area. Lastly, many inner leg members have a bolt member 157 or 167. The latter may be in the form of carriage bolts. To work with the present-inventive manipulating rods as described below, the bolt members can be added if they are not factory supplied.

The configuration of the support legs allows the inner leg member to be moved within the sleeve-like outer leg members, so that the height of the support legs is adjustable when a spring-loaded locking pin (159 and 169) is disengaged from length-wise prefabricated holes in the inner leg members. The locking pins 159 and 169 are reengaged when the proper support leg height is reached. The support legs must also be retracted (i.e., raised to a position close to the trailer body 110) and locked into place when the trailer is being readied for transport.

As has been discussed above, the raising and lowering of the support legs using prior art approaches requires sustained crouching or kneeling for hand manipulation of the legs. As well, two people may also be needed using prior art approaches.

FIG. 2 illustrates two manipulation rods 200 and 300 which are constructed according to the present invention, and which, together, allow the raising and lowering of fifth wheel travel trailer support legs without the need for sustained crouching or kneeling. Additionally, the raising and lowering functions can be accomplished by one person (using both hands, with a separate rod in each). Each support leg is adjusted separately.

A first rod 200 is used to pull and disengage the locking pins 159 and 169. The first rod 200 has a main portion 210, having a pin engagement end 220 for engaging with the locking pins (159 and 169), and a hook portion 230. The hook portion can have many different shapes as needed for different types of locking pins. For example, separate hook portion designs are possible for T-bar type locking pins, L-pin type locking pins, and eyelet type locking pin designs, as well as others. A handle portion 240 has a gripping portion 250 which is orthogonal to the main portion 210. The user can grip the gripping portion 250 of the first rod 200 to pull and disengage the locking pins when needed for an adjustment of the support legs.

While the locking pin is disengaged by pulling on the first manipulation rod, the support legs can be raised and lowered with the aid of a second manipulation rod 300. The second rod 300 has a main portion 300, a working end portion 310 set off from the main portion at an oblique angle as shown, and a hook portion 320 with a hook end 330. A handle portion 340 makes an oblique angle with the main portion 310. At the very end, a gripping portion 350 makes a right angle with the handle portion. In use, the working end 320 engages with the bolt (157, 167) of the inner leg member, while the user pulls on the gripping portion 350 to raise the support legs. The manipulation rod 300 can also ease the dropping of support legs when they are being lowered.

The unique configurations of the manipulation rods allow the ergonomic manipulation of the support legs, including facilitating convenient gripping. Further, the oblique portions 310 and 340 of the second rod 300, which are substantially parallel in the preferred embodiment, allow enough clearance from the travel trailer during support leg adjustment to avoid crouching, while allowing acceptable upward lifting force components.

Many different dimensions and combinations are possible for the first and second manipulation rods, given the teachings of the present invention. However, the preferred embodiment of the first rod 200 contains the following approximate dimensions: main portion, 17 inches; handle portion, 4 inches; end gripping portion 2 inches; and engagement end and hook, 1.25 inches. The preferred embodiment of the second rod contains the following approximate dimensions: main portion, 17 inches; handle portion 4 inches; gripping portion, 2 inches; and working portion 2 inches, with a hook measuring 1.25 inches wide and 1 inch long, separated by a 0.5 to 1 inch separation. Different rod diameters and cross-section shapes are also possible, given the teachings of the present invention. However, the preferred embodiment for both rods uses 5/16 inch circular cross-sections.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

It is expected that there could be numerous variations of the design of this invention.

Finally, it is envisioned that the components of the device may be constructed of a variety of materials.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A method for manipulating the support legs of a fifth wheel travel trailer, said method comprising:
disengaging a support leg locking pin via a first rod having a pin engaging end and a handling end, said first rod being of sufficient length to allow a user to disengage said support leg locking pin without crouching under said fifth wheel travel trailer; and
while said support leg locking pin is disengaged, raising a support leg via a second rod adapted to be engaged at a first end to said support leg near its free end, and a second end of said second rod adapted to being pulled by a user, said second rod also being of sufficient length to allow a user to raise said support leg without crouching under said fifth wheel travel trailer;
said second rod comprising:
a main portion;
a handle portion oriented at a non-right angle from the centerline of said main portion, and having at its end, a bent gripping portion; and
a working portion oriented at a non-right angle from the centerline of said main portion, and having at its end, a hook portion adapted to grip a bolt member of said support leg.

2. The method of claim 1, wherein said pin engaging end of said first rod is adapted to engage with a T-bar type locking pin.

3. The method of claim 1, wherein said pin engaging end of said first rod is adapted to engage with an L-pin type locking pin.

4. The method of claim 1, wherein said pin engaging end of said first rod is adapted to engage with an eyelet type locking pin.

5. The method of claim 1, wherein said bent gripping portion is substantially orthogonal to the rest of said handle portion.

6. The method of claim 1, wherein the length of said second rod is at least 18 inches.

7. The method of claim 1, wherein the length of said second rod is at least 18 inches.

8. The method of claim 1, wherein the main portion of said second rod is substantially 17 inches long, said bent gripping portion is substantially 2 inches long, the rest of said handle portion is substantially 4 inches long, and said working portion is substantially 2 inches long.

9. A pair of manipulating rods adapted to manipulate the support legs of a fifth wheel travel trailer, said pair comprising:
a first rod adapted to disengage a support leg locking pin, said first rod having a pin engaging end and a handling end, said first rod being of sufficient length to allow a user to disengage said support leg locking pin without crouching under said fifth wheel travel trailer; and
a second rod adapted to, while said support leg locking pin is disengaged, raise a support by engaging said second rod at a first end to said support leg near its free end, and a second end of said second rod adapted to being pulled by a user, said second rod also being of sufficient length to allow a user to raise said support leg without crouching under said fifth wheel travel trailer;
said second rod comprising:
a main portion;
a handle portion oriented at a non-right angle from the centerline of said main portion, and having at its end, a bent gripping portion; and
a working portion oriented at a non-right angle from the centerline of said main portion, and having at its end, a hook portion adapted to grip a bolt member of said support leg.

10. The pair of manipulating rods of claim 9, wherein said pin engaging end of said first rod is adapted to engage with a T-bar type locking pin.

11. The pair of manipulating rods of claim 9, wherein said pin engaging end of said first rod is adapted to engage with an L-pin type locking pin.

12. The pair of manipulating rods of claim 9, wherein said pin engaging end of said first rod is adapted to engage with an eyelet type locking pin.

13. The pair of manipulating rods of claim 9, wherein said bent gripping portion is substantially orthogonal to the rest of said handle portion.

14. The pair of manipulating rods of claim 9, wherein the length of said second rod is at least 18 inches.

15. The pair of manipulating rods of claim 9, wherein the length of said second rod is at least 18 inches.

16. The pair of manipulating rods of claim 9, wherein the main portion of said second rod is substantially 17 inches long, said bent gripping portion is substantially 2 inches long, the rest of said handle portion is substantially 4 inches long, and said working portion is substantially 2 inches long.

17. A pair of manipulating rods adapted to manipulate the support legs of a fifth wheel travel trailer, said pair consisting of:
a first rod adapted to disengage a support leg locking pin, said first rod having a pin engaging end and a handling end, said first rod being of sufficient length to allow a user to disengage said support leg locking pin without crouching under said fifth wheel travel trailer; and
a second rod adapted to, while said support leg locking pin is disengaged, raise a support by engaging said second rod at a first end to said support leg near its free end, and a second end of said second rod adapted to being pulled by a user, said second rod also being of sufficient length to allow a user to raise said support leg without crouching under said fifth wheel travel trailer;
said second rod consisting of:
a main portion;
a handle portion oriented at a non-right angle from the centerline of said main portion, and having at its end, a bent gripping portion; and
a working portion oriented at a non-right angle from the centerline of said main portion, and having at its end, a hook portion adapted to grip a bolt member of said support leg.
